(19) United States
(12) Patent Application Publication
(10) Pub. No.: US 2026/0364798 A1
(43) Pub. Date: Nov. 19, 2026

(54) CONTROL SYSTEM AND CONTROL METHOD FOR WALKING ROBOT

(71) Applicant: THK CO., LTD., Tokyo (JP)

(72) Inventor: Yuki Kusakabe, Tokyo (JP)

(73) Assignee: THK CO., LTD., Tokyo (JP)

(21) Appl. No.: 19/140,619

(22) PCT Filed: Dec. 12, 2023
(86) PCT No.: PCT/JP2023/044354

§ 371 Date: Jun. 18, 2025

(30) Foreign Application Priority Data
Dec. 22, 2022 (JP) 2022-205367

(51) Int. Cl. B25J 9/16; B25J 19/00; B62D 57/032

(52) U.S. Cl. CPC B25J 9/1674; B25J 19/0004; B62D 57/032

(57) ABSTRACT

Provided is a walking robot control system that prevents a spring from rapidly changing the attitude of a leg portion of a walking robot when the walking robot falls. A control system for a walking robot having: an actuator (12a) that drives a joint; and a spring that applies a spring force to the joint includes: a motor control device (8) configured to drive the actuator (12a) ; and a controller (7) configured to transmit a command signal that controls the motor control device (8), and upon the controller (7) determining that the walking robot has fallen, the motor control device (8) brakes the actuator (12a).

### TECHNICAL FIELD

The present invention relates to a control system and control method for a walking robot.

### BACKGROUND ART

Walking robots that imitate a person's or animal's manner of walking are being developed. Patent Literature 1 discloses a bipedal robot including a waist portion and two leg portions. The two leg portions of the bipedal robot alternately repeat stance and swing to move in a bipedal manner.

Actuators that drive joints of the walking robot respectively are incorporated in the joints respectively. However, using the actuators alone has a problem that energy efficiency decreases since electric power also needs to be supplied to the actuators to support the weight of the bipedal robot.

In order to solve this problem, the walking robot of Patent Literature 1 is provided with a spring in parallel with the actuator, at a knee joint of each of the leg portions. A spring force of each of the springs acts in a direction in which the knee joint extends. The each of the springs is provided in parallel with its respective actuator, so that torque required for the actuator can be reduced by the spring force. If the spring forces are balanced with the torques acting on the knee joints under the walking robot's own weight when the walking robot is at rest, the torques that are required for the actuators when the walking robot is at rest can be reduced.

### CITATION LIST

### Patent Literature

Patent Literature 1: JP 2003-103480 A

### SUMMARY OF INVENTION

### Technical Problem

However, in terms of the walking robot described in Patent Literature 1, when the walking robot falls, the elastic energy stored in the springs is rapidly released. As a result, there is a problem that the attitude of the walking robot changes rapidly. For example, if the springs are provided to the knee joints of the leg portions, there is a problem that the knee joints extend rapidly. This problem occurs particularly when the reduction ratio of each of the actuators is reduced to move the walking robot at high speed.

It is conceivable that the joints to each of which the spring is attached are locked to prevent their rapid extension at the time of a fall. However, if the joints are locked, the elastic energy remains stored in the springs. Therefore, in the case of an emergency such as a fall, a failure is expected. There is also a risk of injury due to heat or the elastic energy if the elastic energy is unexpectedly released when a person is around for maintenance. It is desirable that the robot is at rest in a state where the elastic energy has been ejected before a person approaches the robot. Also, when the energy is released, if it is simply released, again, the elastic energy is rapidly ejected, and there is the risk of injury. Furthermore, if the joints are locked, a change in attitude due to the elastic energy of the springs can be prevented. However, a risk that the robot itself is damaged by an external force (impact) at the time of a fall increases. At the time of a fall, the joints are backdriven, so that the external force cannot be evaded and, therefore, the locking mechanism and the joints receive the external force directly. From the above, it is hard to say that the use of the lock mechanism is most suitable.

The present invention has been made in view of the above problems, and an object thereof is to provide a control system and control method for a walking robot that prevents a spring from rapidly changing the attitude of the walking robot when the walking robot falls.

### Solution to Problem

In order to solve the above problems, one aspect of the present invention is a control system for a walking robot having: an actuator that drives a joint; and a spring that applies a spring force to the joint, the control system including: a motor control device configured to drive the actuator; and a controller configured to transmit a command signal that controls the motor control device, in which upon the controller determining that the walking robot has fallen, the motor control device brakes the actuator.

Another aspect of the present invention is a control system for a walking robot having: an actuator that drives a knee joint; and a spring that applies a spring force to the knee joint, the control system including a motor control device configured to drive the actuator, in which the motor control device brakes the actuator to prevent the spring from extending the knee joint.

### Advantageous Effects of Invention

According to the one aspect of the present invention, when the controller determines that the walking robot has fallen, the motor control device brakes the actuator, in other words, shifts the actuator to a braked state. Therefore, it is possible to suppress rapid release of elastic energy stored in the spring while releasing the elastic energy, and it is possible to prevent the spring from rapidly changing the attitude of the walking robot. Moreover, if the joint is locked, the elastic energy remains stored in the spring, and the walking robot is easily damaged by an external force associated with the fall. It is possible to solve the problems locking the joint by suppressing the rapid release of the elastic energy stored in the spring while releasing the elastic energy.

According to the other aspect of the present invention, since the motor control device brakes the actuator, in other words, shifts the actuator to the braked state, it is possible to suppress the rapid release of the elastic energy stored in the spring while releasing the elastic energy, and it is possible to prevent the spring from rapidly extending the knee joint of the walking robot.

Note that in the other aspect of the present invention, the motor control device may brake the actuator when the robot falls, or the motor control device may brake the actuator when the robot does not fall and is in at least one of cases of FIGS. 6 to 8 described below.

### BRIEF DESCRIPTION OF DRAWINGS

FIG. 1 is a schematic diagram of a walking robot of the embodiment.

FIG. 2 is a diagram illustrating a knee joint of the walking robot of the embodiment.

FIG. 3 is a block diagram illustrating a configuration of a control system for the walking robot of the embodiment.

FIG. 4 is a block diagram illustrating the configuration of the control system for the walking robot of the embodiment.

FIG. 5 is a block diagram illustrating a flow in which an actuator shifts to a braked state (when a controller determines that the walking robot has fallen).

FIG. 6 is a block diagram illustrating a flow in which the actuator shifts to the braked state (when a motor control device detects an abnormality in the actuator or in itself).

FIG. 7 is a block diagram illustrating a flow in which the actuator shifts to the braked state (when an operator inputs a stop command for the walking robot).

FIG. 8 is a block diagram illustrating a flow in which the actuator shifts to the braked state (when a testing device operating the walking robot transmits the stop command).

### DESCRIPTION OF EMBODIMENTS

A control system and control method for a walking robot of an embodiment of the present invention are described hereinafter with reference to the accompanying drawings. However, the control system and control method for the walking robot of the present invention can be embodied in various forms, and are not limited to the embodiment described in the present description. The embodiment is provided with the intention of enabling those skilled in the art to fully understand the scope of the invention by fully disclosing the description.

### Walking Robot

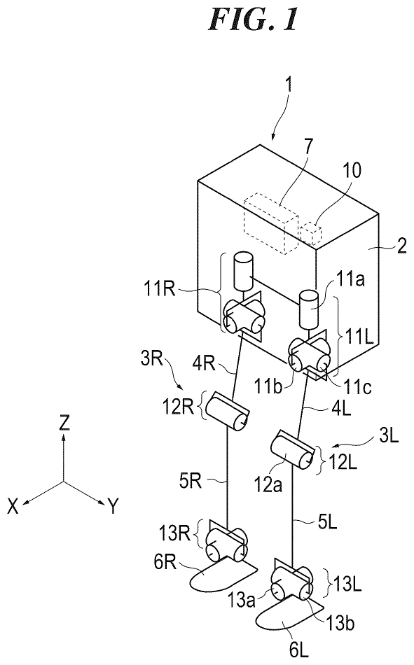

FIG. 1 is a schematic diagram of a walking robot 1 of the embodiment. In FIG. 1, a travel direction of the walking robot 1 is assumed to be an X-axis direction, a left-and-right direction is assumed to be a Y-axis direction, and an up-and-down direction is assumed to be a Z-axis direction. FIG. 1 illustrates the walking robot 1 having only the lower half of the body without the upper half, but the walking robot 1 may have the upper half of the body.

The walking robot 1 of the embodiment includes a waist portion 2 and a pair of left and right leg portions 3L and 3R coupled to a lower end portion of the waist portion 2. The leg portions 3L and 3R include thigh links 4L and 4R, lower leg links 5L and 5R, and foot portions 6L and 6R. The thigh links 4L and 4R are coupled to the waist portion 2 via hip joints 11L and 11R having three degrees of freedom. The lower leg links 5L and 5R are coupled to the thigh links 4L and 4R via knee joints 12L and 12R having one degree of freedom. The foot portions 6L and 6R are coupled to the lower leg links 5L and 5R via ankle joints 13L and 13R having two degrees of freedom.

The hip joints 11L and 11R include actuators 11a and 11a that rotate the thigh links 4L and 4R about the yaw axis (Z-axis) relative to the waist portion 2, include actuators 11b and 11b that rotate the thigh links 4L and 4R about the roll axis (X-axis) relative to the waist portion 2, and include actuators 11c and 11c that rotate the thigh links 4L and 4R about the pitch axis (Y-axis) relative to the waist portion 2.

The knee joints 12L and 12R include actuators 12a and 12a that rotate the lower leg links 5L and 5R about the pitch axis (Y-axis) relative to the thigh links 4L and 4R. The ankle joints 13L and 13R include actuators 13a and 13a that rotate the foot portions 6L and 6R about the roll axis (X-axis) relative to the lower leg links 5L and 5R, and include actuators 13b and 13b that rotate the foot portions 6L and 6R about the pitch axis (Y-axis) relative to the lower leg links 5L and 5R.

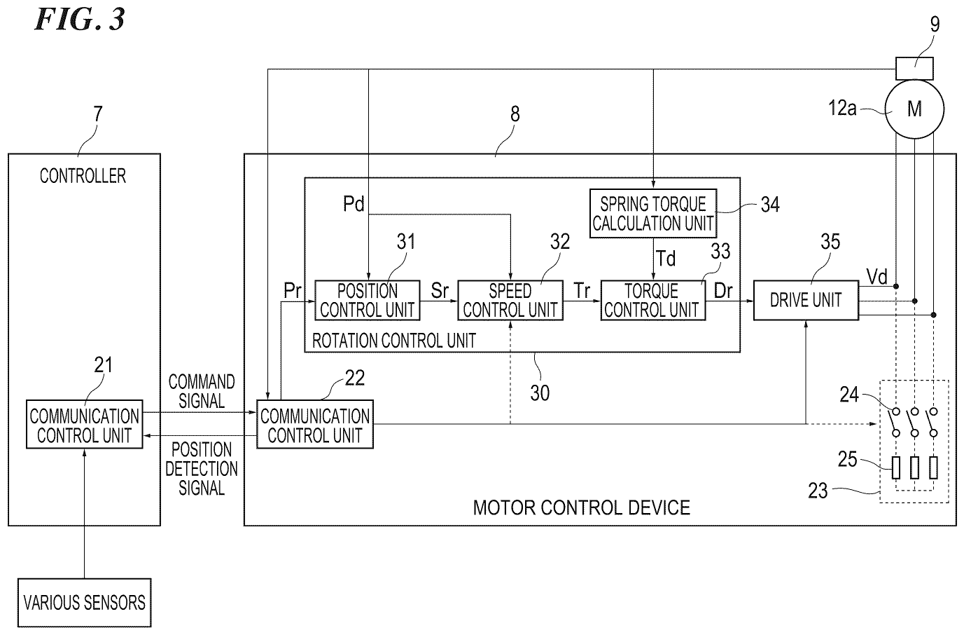

Each of the actuators 11a to 11c, 12a, 13a, and 13b includes a motor such as a brushless DC servomotor and a reduction gear. For the each of the actuators, a motor control device 8 (refer to FIG. 3) that drives the actuator, and a position detector 9 (refer to FIG. 3) that detects the rotational position of the motor are unitized.

As described above, the leg portions 3L and 3R each include six actuators 11a to 11c, 12a, 13a, and 13b, and have 12 degrees of freedom in total. The drive of the 12 actuators is controlled by a controller 7 (refer to FIG. 3) and the motor control devices 8 (refer to FIG. 3). Therefore, it is possible to provide desired motion to the leg portions 3L and 3R and to cause the walking robot 1 to walk.

The waist portion 2 is provided with the controller 7. Moreover, the waist portion 2 is provided with various sensors 10 such as an acceleration sensor that detects the acceleration of the center of gravity of the walking robot 1, a gyro sensor that detects the inclination angle of the walking robot, and an inertial measurement unit (IMU) into which these sensors are unitized.

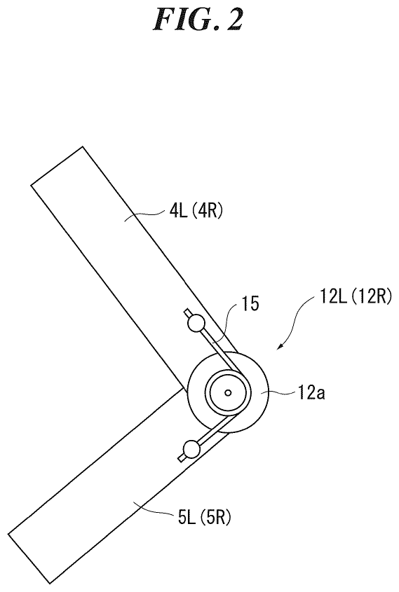

FIG. 2 illustrates the knee joints 12L/12R of the leg portions 3L/3R. The reference numeral 4L/4R denotes the thigh link, the reference numeral 5L/5R denotes the lower leg link, and the reference numeral 12a denotes the actuator of the knee joint 12L/12R. The knee joint 12L/12R is provided with a spring 15 in parallel with the actuator 12a. The spring 15 applies a spring force in a direction in which the knee joint 12L/12R extends. The spring 15 is, for example, a torsion spring, a coil spring or a leaf spring. Note that the joints provided with the springs 15 are not limited to the knee joints 12L and 12R, and may be, for example, the pitch axis or the roll axis of the hip joints 11L and 11R, or arm joints of the upper half of the body.

### Control System

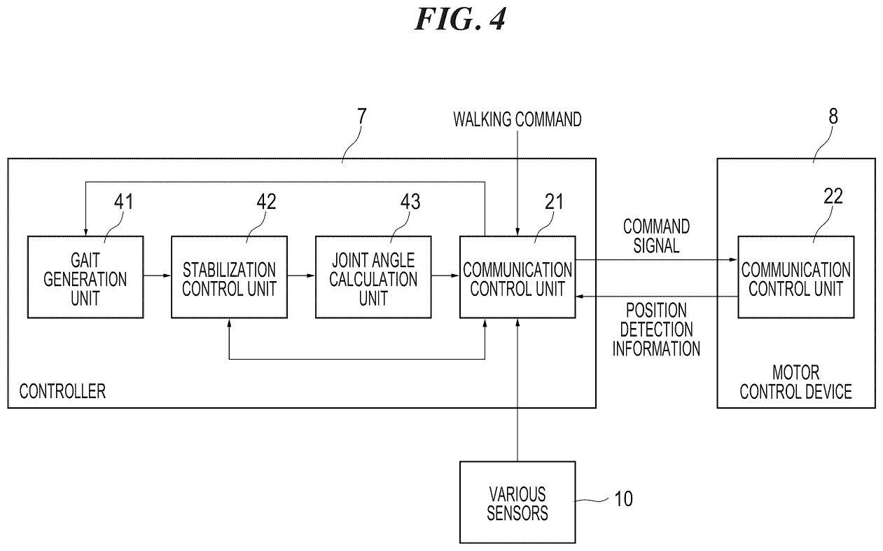

FIGS. 3 and 4 are block diagrams illustrating a configuration of a control system for the walking robot 1 of the embodiment. As illustrated in FIG. 3, the control system includes the controller 7 and the motor control device 8. The controller 7 transmits a command signal to the motor control device 8. The motor control device 8 drives the actuator 12a in response to the command signal received from the controller 7.

A communication connection is established on a communication line between the controller 7 and the motor control device 8 in such a manner as to enable transmission and reception. The controller 7 includes a communication control unit 21 that transmits and receives data and controls communication. Similarly, the motor control device 8 also includes a communication control unit 22 that transmits and receives data and controls communication. The communication control units 21 and 22 also have a function of detecting an abnormality in communication.

FIG. 4 illustrates only the motor control device 8 of the knee joint 12L/12R. However, 12 motor control devices 8 are provided, making up the number of the actuators 11a to 11c, 12a, 13a, and 13b. The motor control devices 8 of the other joints also have substantially the same configuration as the motor control devices 8 of the knee joints 12L and 12R.

### Motor Control Device

As illustrated in FIG. 3, the controller 7 transmits a command signal to the motor control device 8. Main command information included in the command signal is a walking command for causing the walking robot 1 to walk, and a stop command for braking the actuator 12a. The walking command mainly includes a position command for a rotation control unit 30.

The motor control device 8 includes the rotation control unit 30 that generates a torque command for operating the motor of the actuator 12a, and a drive unit 35 that generates a drive voltage for energizing the motor of the actuator 12a in response to the torque command.

The rotation control unit 30 controls the position, speed, and torque of the motor of the actuator 12a. The rotation control unit 30 includes a position control unit 31 that controls the position, a speed control unit 32 that controls the speed, a torque control unit 33 that controls the torque, and a spring torque calculation unit 34. Note that the spring torque calculation unit 34 may be provided in the controller 7.

When the controller 7 transmits a position command, the motor control device 8 controls the actuator 12a in such a manner that the rotational position of the motor follows the received position command Pr. Specifically, the communication control unit 22 outputs the received position command Pr to the position control unit 31. The position control unit 31 calculates a position error on the basis of the position command Pr and position detection information Pd from the position detector 9, and multiplies the position error by position gain to calculate a speed command Sr.

The speed control unit 32 differentiates the position detection information Pd from the position detector 9, and calculates speed information. Moreover, the speed control unit 32 calculates a speed error on the basis of the speed command Sr and the speed information, and performs, for example, proportional and integral calculations on the speed error to calculate a torque command Tr.

The spring torque calculation unit 34 calculates spring torque on the basis of the position detection information from the position detector 9, calculates torque Td for correction on the basis of the spring torque, and inputs the torque Td for correction into the torque control unit 33. The torque control unit 33 calculates a voltage command Dr on the basis of the torque command Tr and the torque Td for correction.

Note that the spring torque calculation unit 34 may calculate a position for correction and/or a speed for correction on the basis of the spring torque and input the position for correction and/or the speed for correction into the position control unit 31 and/or the speed control unit 32. Moreover, it may be configured in such a manner that the spring torque calculation unit 34 is provided to the controller 7 as described above, and the controller 7 transmits the torque for correction, the position for correction, and/or the speed for correction to the motor control device 8.

The rotation control unit 30 and the communication control unit 22 include, for example, a CPU, ROM, and RAM that are connected via a bus. The position control unit 31, the speed control unit 32, the torque control unit 33, and the spring torque calculation unit 34 of the rotation control unit 30, and the communication control unit 22 are achieved by the CPU executing a program stored in the ROM.

The drive unit 35 generates a drive voltage Vd in response to the voltage command Dr outputted from the rotation control unit 30. The drive unit 35 includes an inverter including a pulse width modulation (PWM) circuit and switching elements. The drive unit 35 generates a pulse signal of which the pulse width has been modulated by the PWM circuit in response to the voltage command Dr, and controls turning-on/off of the switching elements of the inverter with the pulse signal to generate the drive voltage Vd. The drive unit 35 applies the drive voltage Vd to a winding of each phase to drive the actuator 12a.

When the controller 7 determines that the walking robot 1 has fallen, the controller 7 transmits a stop command to the motor control device 8. When the controller 7 transmits the stop command, the motor control device 8 switches the control from a walking mode that causes the walking robot 1 to walk to a stop mode that brakes the actuator 12a. In the stop mode, for example, the stop command is inputted into the drive unit 35, the windings of the motor are short-circuited using the switching elements of the inverter, and the motor is braked using winding resistance.

The control in the stop mode is not limited to the above, and it may be configured in such a manner that a zero speed command is inputted into the speed control unit 32, and the speed control unit 32 outputs braking torque that stops the rotation of the motor.

Moreover, the control in the stop mode is not limited to the above, and the motor control device 8 may be provided with a dynamic braking circuit 23 (refer to a broken line of FIG. 3). The dynamic braking circuit 23 includes a switch 24 and a resistor 25 in each of the phases of the windings of the motor. One ends of the switches 24 are connected to their respective windings, and the other ends of the switches 24 are connected to their respective resistors 25. The other ends of the resistors 25 are connected together. The turning-on/off of the switches 24 are controlled by the communication control unit 22. The communication control unit 22 turns on and off the switches 24, and therefore direct coupling and decoupling of the resistors 25 can be switched.

### Controller

As illustrated in FIG. 4, in order to cause the walking robot 1 to walk, the controller 7 receives a walking command from, for example, a host computer or an operator, and transmits a position command (command signal) to the motor control device 8.

The controller 7 includes a gait generation unit 41, a stabilization control unit 42, a joint angle calculation unit 43, and the communication control unit 21. The gait generation unit 41 generates a gait in such a manner as to satisfy the walking command. The walking command is a set of a step length and a turning angle. The gait is a set of a waist portion position and attitude trajectory, a foot portion position and attitude trajectory, and a ZMP trajectory.

In order to prevent the walking robot 1 from falling due to an unexpected disturbance, the stabilization control unit 42 estimates the attitude of the walking robot 1 on the basis of information of the various sensors 10 and corrects the gait generated by the gait generation unit 41. A geometric position of each of the links of the leg portions 3L and 3R is calculated on the basis of not only the information of the various sensors 10 but also the position detection information of the position detector 9. Therefore, the estimation accuracy of the attitude can be enhanced.

Moreover, when the attitude of the walking robot 1 is inclined and cannot be controlled even if the actuators 11a to 11c, 12a, 13a, and 13b are controlled, the stabilization control unit 42 determines that the walking robot 1 has fallen. At this point in time, the controller 7 transmits a stop command (command signal) to the motor control device 8.

Note that the stabilization control unit 42 may determine that the walking robot 1 has fallen when the estimated attitude of the walking robot 1 is inclined by a predetermined amount or more. Moreover, the stabilization control unit 42 may control the walking robot 1 in such a manner that an impact that is applied to the walking robot 1 at the time of a fall decreases, and then determine that the walking robot 1 has fallen. Furthermore, the stabilization control unit 42 may monitor power that is supplied to the actuators of all the axes and determine whether the walking robot 1 has fallen on the basis of a voltage drop or the state of current of a power supply.

The joint angle calculation unit 43 converts the corrected gait generated by the stabilization control unit 42 into a position command for each of the actuators 11a to 11c, 12a, 13a, and 13b of the joints by inverse kinematics calculations.

The communication control unit 21 transmits the position command to the motor control device 8. The gait generation unit 41, the stabilization control unit 42, the joint angle calculation unit 43, and the communication control unit 21 include, for example, a CPU, ROM, and RAM that are connected via a bus. They are achieved by the CPU executing a program stored in the ROM.

### Flow in which Actuators Shift to Braked State (When Controller Determines That Walking Robot Has Fallen)

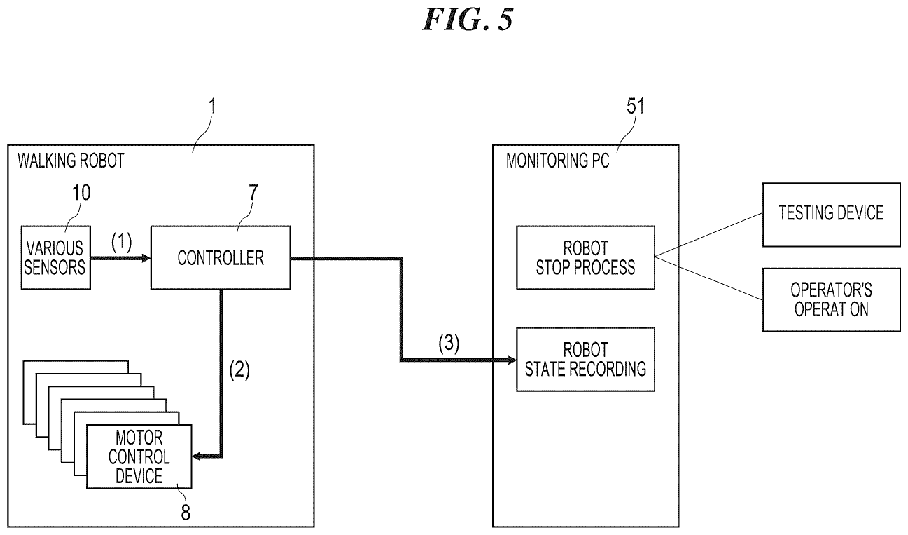

As illustrated in FIG. 5, the controller 7 estimates the attitude of the walking robot 1 on the basis of the information (1) from the various sensors 10. When the attitude of the walking robot 1 is inclined and cannot be controlled even if the actuators 11a to 11c, 12a, 13a, and 13b are controlled, the controller 7 determines that the walking robot 1 has fallen. At this point in time, the controller 7 transmits a stop command to the motor control devices 8 of all the axes that drive the actuators 11a to 11c, 12a, 13a, and 13b (2). The motor control devices 8 of all the axes brake the actuators 11a to 11c, 12a, 13a, and 13b of all the axes in response to the stop command from the controller 7. The controller 7 notifies a monitoring PC 51 (a personal computer) of the braked states of the actuators 11a to 11c, 12a, 13a, and 13b, and the braked states are recorded in the monitoring PC 51 (3).

### Flow in Which Actuators Shift to Braked State (When Motor Control Device Detects Abnormality in Actuator or in Itself)

Not only when the controller 7 determines that the walking robot 1 has fallen, but also in the following cases, the motor control devices 8 brake the actuators 11a to 11c, 12a, 13a, and 13b.

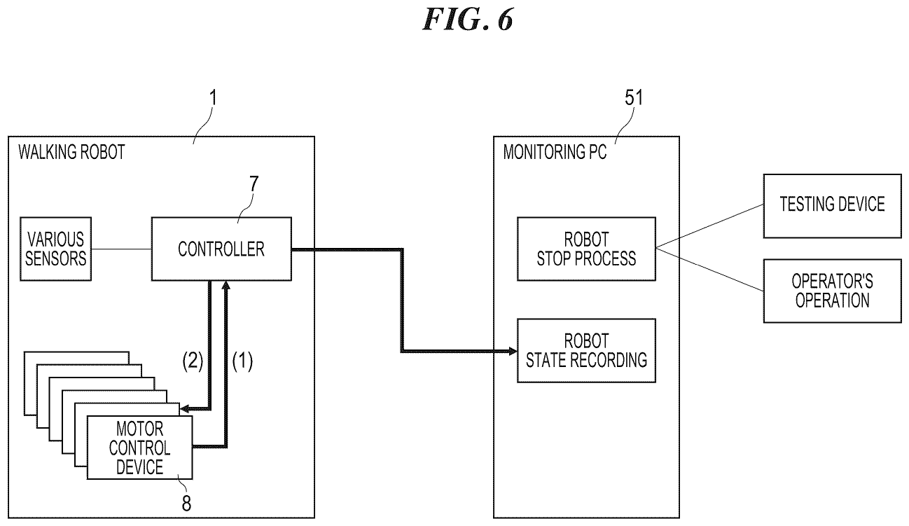

As illustrated in FIG. 6, when the motor control device 8 detects an abnormality in the motor (such as overcurrent in the motor or an abnormality in the position detector 9), or an abnormality in itself (such as damage), the motor control device 8 that has detected an abnormality shuts off the power to its actuator 11a/11b/11c/12a/13a/13b, and brakes the actuator 11a/11b/11c/12a/13a/13b. The motor control device 8 that has detected the abnormality transmits abnormality information to the controller 7 (1).

When receiving the abnormality information, the controller 7 determines that the operation of the walking robot 1 cannot be continued, and transmits a stop command to the motor control devices 8 in which no abnormality has been detected (2). The motor control devices 8 in which no abnormality has been detected brake their respective actuators 11a/11b/11c/12a/13a/13b in response to the stop command from the controller 7.

### Flow in which Actuators Shift to Braked State (When Motor Control Device Detects Abnormality in Reception of Command Signal of Controller)

Substantially the same applies when the motor control device 8 detects an abnormality in the reception of a command signal of the controller 7. The controller 7 transmits a command signal to the motor control device 8 at regular intervals. The connection between the controller 7 and the motor control device 8 is checked at regular intervals. If there has been no response in a predetermined time period, it is determined that there is an abnormality in the communication line inside the walking robot 1. The motor control device 8 that has detected the abnormality shuts off the power to its actuator 11a/11b/11c/12a/13a/13b, and brakes the actuator 11a/11b/11c/12a/13a/13b. The motor control device 8 that has detected the abnormality then transmits abnormality information to the controller 7 (1). The controller 7 transmits a stop command to the motor control devices 8 in which no abnormality has been detected (2). The motor control devices 8 in which no abnormality has been detected brake their respective actuators 11a/11b/11c/12a/13a/13b in response to the stop command from the controller 7.

### Flow in Which Actuators Shift to Braked State (When Operator Inputs Stop Command for Walking Robot)

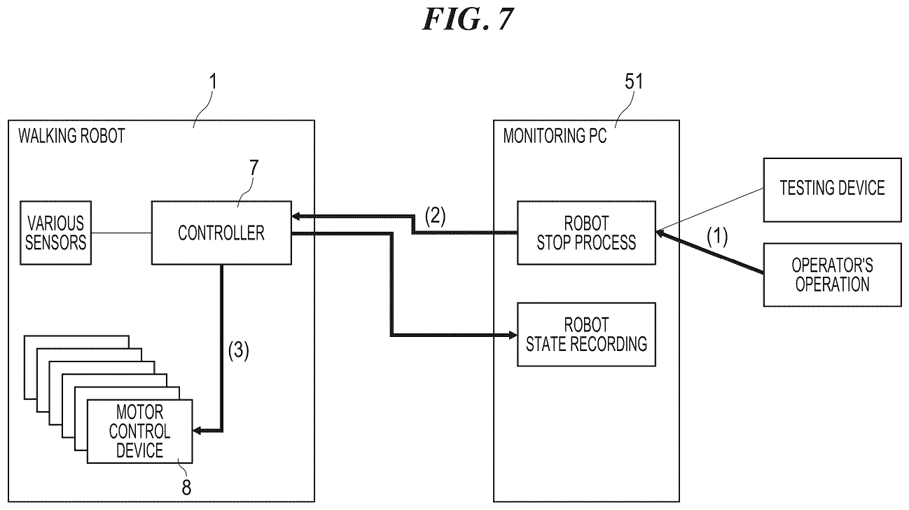

As illustrated in FIG. 7, when an operator inputs a stop command for the walking robot 1 (1), the motor control devices 8 brake the actuators 11a to 11c, 12a, 13a, and 13b of all the axes. When the operator determines that the walking robot 1 should be stopped, the operator inputs a stop command to an operating device such as a personal computer. The operating device is connected to the monitoring PC 51 and the controller 7 via a network. The stop command inputted by the operator is transmitted to the controller 7 via the network ((1) and (2)). When accepting the stop command, the controller 7 transmits a stop command to the motor control devices 8 of all the axes (3).

### Flow in Which Actuators Shift to Braked State (When Testing Device Operating Walking Robot Transmits Stop Command)

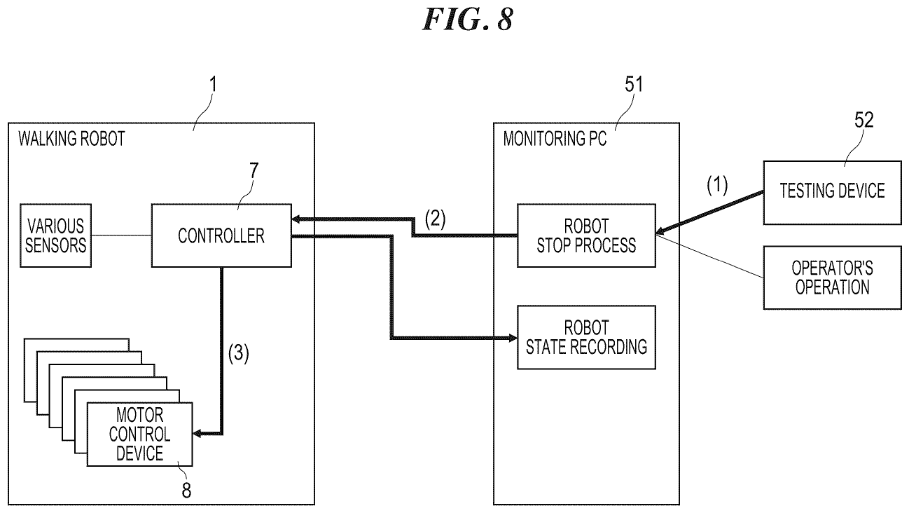

As illustrated in FIG. 8, when a testing device 52 operating the walking robot 1 transmits a stop command (1), the motor control devices 8 brake the actuators 11a to 11c, 12a, 13a, and 13b of all the axes. Sensors and switches are attached to the fence and door of the testing device 52 (a testing device including, for example, a crane that hoists the walking robot 1). The sensors and the switches are connected to the monitoring PC 51 and the controller 7 via the network. When the fence and the door open or close unnecessarily during operation of the walking robot 1, the testing device 52 transmits a stop command to the controller 7 ((1) and (2)). When accepting the stop command, the controller 7 transmits a stop command to the motor control devices 8 of all the axes (3).

Effects of the control system for the walking robot 1 of the embodiment are described.

When the controller 7 determines that the walking robot 1 has fallen, the motor control devices 8 brake the actuators 12a, in other words, shift the actuators 12a to the braked state. Therefore, it is possible to suppress rapid release of the elastic energy stored in the springs 15 while releasing the elastic energy, and it is possible to prevent the springs 15 from rapidly changing the attitudes of the leg portions 3L and 3R of the walking robot 1. Moreover, when the knee joints 12L and 12R are locked, the elastic energy remains stored in the springs 15, and the walking robot 1 is easily damaged by an external force associated with a fall. It is possible to solve the problems locking the knee joints 12L and 12R by suppressing the rapid release of the elastic energy stored in the springs 15 while releasing the elastic energy.

The motor control devices 8 brake the knee joints 12L and 12R that change the attitudes of the leg portions 3L and 3R greatly. Therefore, it is possible to effectively prevent the attitudes of the leg portions 3L and 3R from changing rapidly.

When the controller 7 determines that the walking robot 1 has fallen, not only the actuators 12a of the knee joints 12L and 12R but also two or more of the actuators 11a to 11c, 12a, 13a, and 13b (for example, of all the axes) are braked. Therefore, the leg portions 3L and 3R can be braked more safely.

The controller 7 brakes the actuators 11a to 11c, 12a, 13a, and 13b not only when determining that the walking robot 1 has fallen but also at the times illustrated in FIGS. 6 to 8, the leg portions 3L and 3R can be braked more safely.

Note that the present invention is not limited to concretization of the above embodiment, and can be concretized in other embodiments without changing the purport of the present invention.

In the above embodiment, the example has been described in which the walking robot is a bipedal robot. However, the walking robot may be a quadrupedal robot.

In the above embodiment, the example has been described in which the actuator directly drives the joint of the leg portion. However, the actuator may drive the joint via a link mechanism. For example, one or more rotating four-bar linkages including the thigh link and the lower leg link may be constructed, and the knee joint may be driven by the actuator driving the one or more rotating four-bar linkages. The actuator may be placed at the thigh link or the lower leg link.

In the above embodiment, the actuator includes the motor and the reduction gear. However, the actuator may include a motor and a ball screw.

The present description is based on Japanese Patent Application No. 2022-205367 filed on Dec. 22, 2022. The entire contents thereof are incorporated herein.

### REFERENCE SIGNS LIST

1 Walking robot
2 Waist portion
3L, 3R Leg portion
7 Controller
8 Motor control device
12L, 12R Knee joint
12a Actuator
15 Spring
23 Dynamic braking circuit
52 Testing device

1. A control system for a walking robot including: an actuator that drives a joint; and a spring that applies a spring force to the joint, the control system comprising:
a motor control device configured to drive the actuator; and
a controller configured to transmit a command signal that controls the motor control device, wherein
upon the controller determining that the walking robot has fallen, the motor control device brakes the actuator.

2. The control system for the walking robot according to claim 1, wherein
the joint is a knee joint of a leg portion, and
the motor control device brakes the actuator to brake extension of the knee joint.

3. The control system for the walking robot according to claim 1, wherein the command signal includes at least a walking command for causing the walking robot to walk and a stop command for braking the actuator.

4. The control system for the walking robot according to claim 1, wherein
the walking robot includes a plurality of actuators that drives a plurality of joints including the joint, and
the control system comprises a plurality of motor control devices that drives the plurality of actuators,
the controller transmits a command signal that controls the plurality of motor control devices, and
upon the controller determining that the walking robot has fallen, the plurality of motor control devices brakes the plurality of actuators.

5. The control system for the walking robot according to claim 1, wherein
at at least one of: a time when the motor control device detects an abnormality in the actuator or in itself; a time when the motor control device detects an abnormality in reception of the command signal of the controller; a time when an operator inputs a stop command for the walking robot; or a time when a testing device that operates the walking robot transmits the stop command,
the motor control device brakes the actuator.

6. A control system for a walking robot including: an actuator that drives a knee joint; and a spring that applies a spring force to the knee joint, the control system comprising a motor control device configured to drive the actuator, wherein
the motor control device brakes the actuator to prevent the spring from extending the knee joint.

7. A control method for a walking robot including: an actuator that drives a joint; and a spring that applies a spring force to the joint, the control method comprising:
a motor control device configured to drive the actuator; and
a controller configured to transmit a command signal that controls the motor control device, wherein
upon the controller determining that the walking robot has fallen, the motor control device brakes the actuator.

8. A control method for a walking robot including: an actuator that drives a knee joint; and a spring that applies a spring force to the knee joint, the control method comprising a motor control device configured to drive the actuator, wherein
the motor control device brakes the actuator to prevent the spring from extending the knee joint.

9. The control system for the walking robot according to claim 2, wherein the command signal includes at least a walking command for causing the walking robot to walk and a stop command for braking the actuator.

10. The control system for the walking robot according to claim 2, wherein
the walking robot includes a plurality of actuators that drives a plurality of joints including the joint, and
the control system comprises a plurality of motor control devices that drives the plurality of actuators,
the controller transmits a command signal that controls the plurality of motor control devices, and
upon the controller determining that the walking robot has fallen, the plurality of motor control devices brakes the plurality of actuators.

11. The control system for the walking robot according to claim 2, wherein at at least one of: a time when the motor control device detects an abnormality in the actuator or in itself; a time when the motor control device detects an abnormality in reception of the command signal of the controller; a time when an operator inputs a stop command for the walking robot; or a time when a testing device that operates the walking robot transmits the stop command, the motor control device brakes the actuator.
